(19) United States
(12) Patent Application Publication
(10) Pub. No.: US 2026/0361038 A1
(43) Pub. Date: Nov. 12, 2026

(54) SHIELD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masami SAKAI, Mie (JP); Shinji TANAKA, Mie (JP); Yutaka KOBAYASHI, Mie (JP); Liping KANG, Mie (JP); Yusuke ITO, Mie (JP); Takeyuki SUZUKI, Mie (JP)

(21) Appl. No.: 19/486,384

(22) PCT Filed: May 13, 2024
(86) PCT No.: PCT/JP2024/017661

§ 371 Date: Nov. 21, 2025

(30) Foreign Application Priority Data
May 25, 2023 (JP) 2023-086175

(51) Int. Cl. H01R 24/40; H01R 103/00

(52) U.S. Cl. CPC H01R 24/40; H01R 2103/00

(57) ABSTRACT

The present invention improves shield performance. This shield connector comprises: a cylindrical first outer conductor (14) having a first spring part (31) and a second spring part (32) that are elastically deformable in the radial direction; and a cylindrical second outer conductor (54) that is in contact with the first spring part (31) and the second spring part (32) in the radial direction. The first spring part (31) and the second spring part (32) are portions defined by a first side slit (24), a second side slit (25), and a third side slit (26) in the axial direction formed in the first outer conductor (14). On the first spring part (31), a first movable-side reinforcing part (35) for increasing the bending rigidity of the first spring part (31) is formed. On the second spring part (32), a second movable-side reinforcing part (38) for increasing the bending rigidity of the second spring part (32) is formed.

### TECHNICAL FIELD

The present disclosure relates to a shield connector.

### BACKGROUND

Patent Document 1 discloses a coaxial connector. This coaxial connector includes a hollow cylindrical shell having a base end part to be crimped to an external conductor of a coaxial cable. Slits extending in an axial direction are formed side by side at equal intervals in a circumferential direction in a tip part of the shell. Out of the shell, parts between the slits function as resiliently deformable spring portions. If the shell is inserted into a receptacle as a connection target, the spring portions resiliently contact the inner surface of the receptacle.

### Prior Art Document

### Patent Document

Patent Document 1: JP 2021-051872 A

### SUMMARY OF THE INVENTION

### Problems to be Solved

To enhance shielding performance in the coaxial connector of this type, it is thought to increase the number of the spring portions and increase a total amount of currents flowing between the shell and the receptacle. However, if the number of the spring portions is increased, a width in the circumferential direction of each spring portion is reduced and a resilient force of one spring is reduced. Thus, a contact resistance at each contact point increases. Therefore, even if the number of the spring portions is increased, it is difficult to effectively reduce the contact resistance.

A shield connector of the present disclosure was completed on the basis of the above situation and aims to improve shielding performance.

### Means to Solve the Problem

The present disclosure is directed to a shield connector with a tubular first outer conductor including a spring portion resiliently deformable in a radial direction and a tubular second outer conductor configured to contact the spring portion in the radial direction, the spring portion being a part defined by a side slit in an axial direction formed in the first outer conductor, and the spring portion being formed with a reinforcing portion for enhancing flexural rigidity of the spring portion.

### Effect of the Invention

According to the present disclosure, shielding performance can be improved.

### BRIEF DESCRIPTION OF THE DRAWINGS

FIG. 1 is a perspective view of a first connector of one embodiment when viewed obliquely from an upper front side.

FIG. 2 is a perspective view of the first connector shown in FIG. 1 when viewed obliquely from a lower front side.

FIG. 3 is a side view in section showing a state where the first connector and a second connector are connected.

FIG. 4 is a plan view of the first connector shown in FIG. 1.

FIG. 5 is a side view of the first connector shown in FIG. 1.

FIG. 6 is a bottom view of the first connector shown in FIG. 1.

FIG. 7 is a front view in section of a first outer conductor and a second outer conductor in a connected state cut at contact point portions.

FIG. 8 is a front view in section showing the first and second outer conductors in the connected state cut at reinforcing portions.

FIG. 9 is a plan view showing a developed state before the first outer conductor is formed into a hollow cylindrical shape.

### DETAILED DESCRIPTION TO EXECUTE THE INVENTION

### Description of Embodiments of Present Disclosure

First, embodiments of the present disclosure are listed and described. Arbitrary combinations of a plurality of the embodiments described below without causing any contradiction are also included in forms for carrying out the invention.

(1) The shield connector of the present disclosure is provided with a tubular first outer conductor including a spring portion resiliently deformable in a radial direction and a tubular second outer conductor configured to contact the spring portion in the radial direction, the spring portion being a part defined by a side slit in an axial direction formed in the first outer conductor, and the spring portion being formed with a reinforcing portion for enhancing flexural rigidity of the spring portion. According to this configuration, since the flexural rigidity of the spring portion is enhanced by the reinforcing portion, a stress generated in the spring portion when the spring portion is resiliently deformed in the radial direction is large. In this way, a contact resistance between the first and second outer conductors is reduced, wherefore shielding performance can be improved.

(2) Preferably, in (1), the spring portion has a cantilever shape extending in the axial direction from a tubular supporting portion constituting the first outer conductor, a contact point portion for contacting the second outer conductor is formed on a tip part of the spring portion, and the reinforcing portion is arranged in a region including a base end part connected to the tubular supporting portion, out of the spring portion. According to this configuration, since the base end part serving as a fulcrum during the resilient deformation of the spring portion is reinforced by the reinforcing portion, a resilient force of the spring portion can be effectively enhanced.

(3) Preferably, in (2), the reinforcing portion is formed from the base end part to a boundary portion with the spring portion in the tubular supporting portion in the axial direction. When the spring portion is resiliently deformed, not only the base end part of the spring portion, but also the boundary portion with the spring portion in the tubular supporting portion is deflected. Since the reinforcing portion enhances the rigidity of not only the base end part of the spring portion, but also the boundary portion of the tubular supporting portion, the resilient force of the spring portion can be effectively enhanced.

(4) Preferably, in (2) or (3), the spring portion is formed such that a width of the base end part is larger than that of the tip part. According to this configuration, the resilient force of the spring portion can be effectively enhanced.

(5) Preferably, in (1) to (3), the reinforcing portion is shaped to project radially outward from an outer peripheral surface of the first outer conductor. The first outer conductor is formed by winding a metal plate material in the form of a flat plate formed with the spring portion and the reinforcing portion around a cylindrical core metal. Since the reinforcing portion projects radially outward, the core metal needs not be formed with a recess for avoiding interference with the reinforcing portion.

(6) Preferably, in (2) or (3), the reinforcing portion is shaped by causing a widthwise central part of the base end part to project in the radial direction, a side edge part along the side slit, out of the base end part, functions as a reinforcement held portion when the reinforcing portion is formed by striking, and a base end slit defining the base end part, out of the side slit, extends in parallel to an axis of the first outer conductor. According to this configuration, since a side edge of the reinforcement held portion is parallel to the axis, the reinforcement held portion is easily held by a jig in a process of forming the reinforcing portion by striking.

### Details of Embodiment of Present Disclosure

### Embodiment

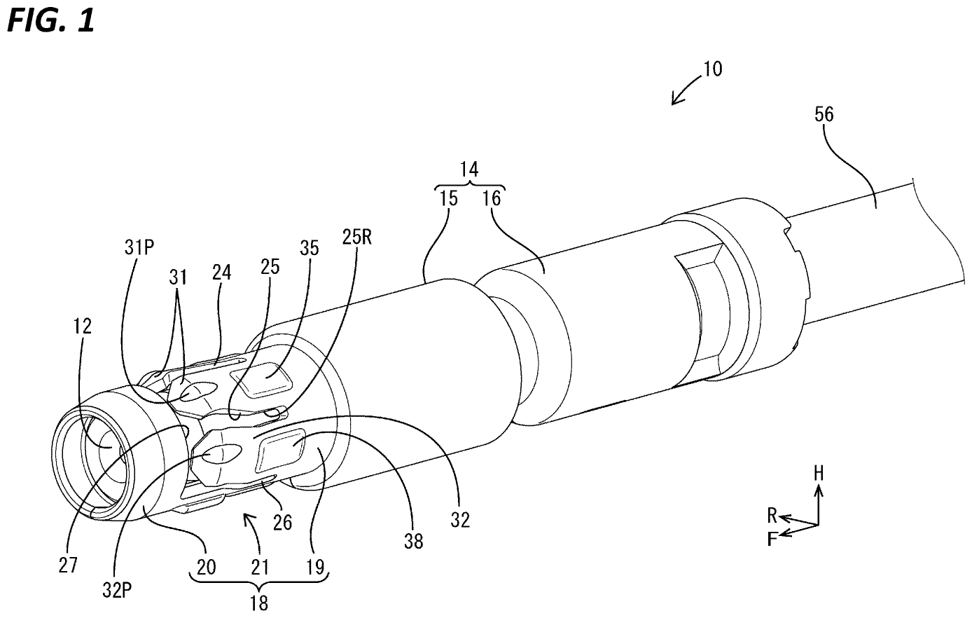

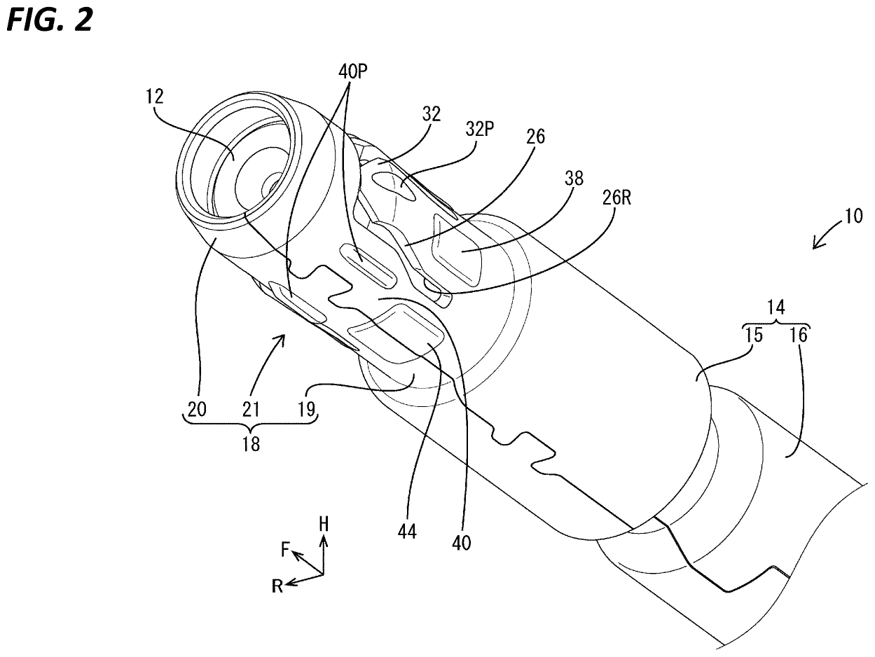

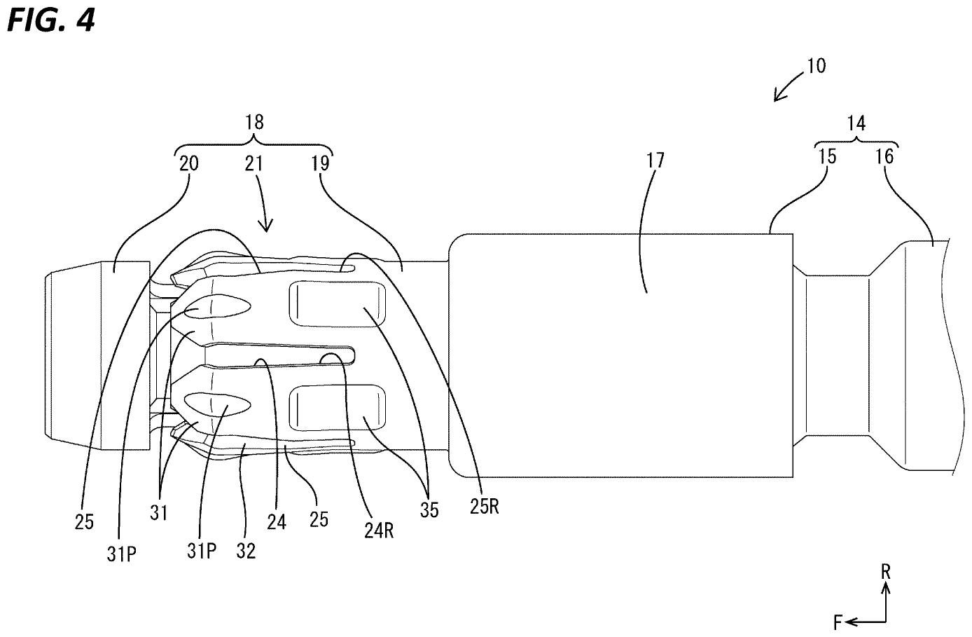

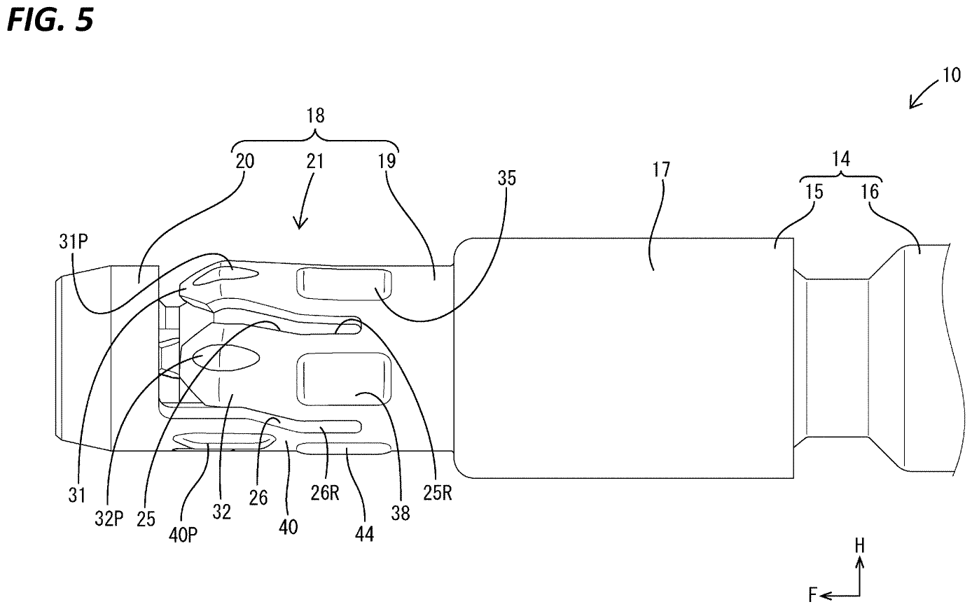

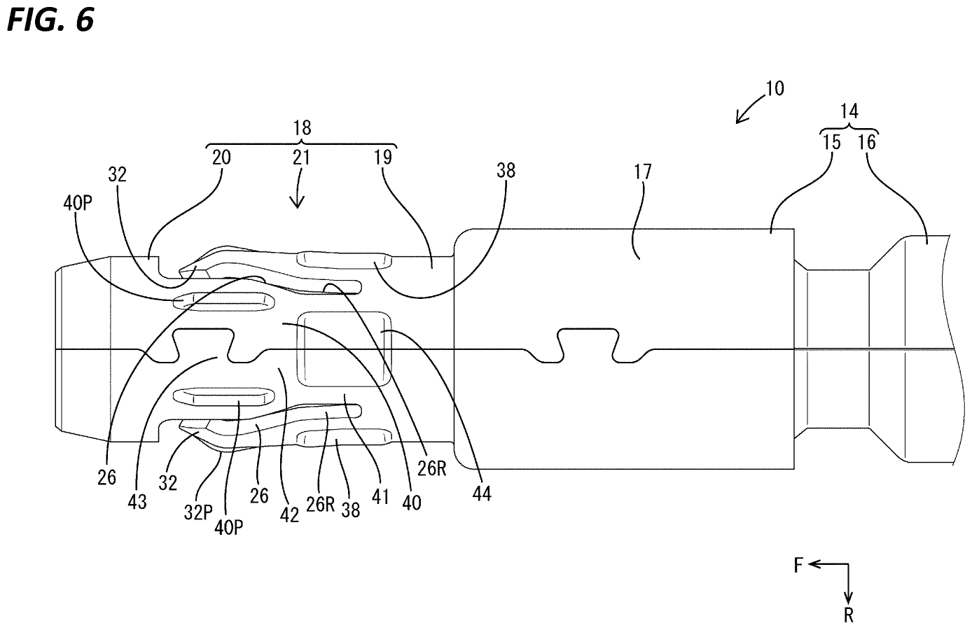

A shield connector of one specific embodiment of the present disclosure is described with reference to FIGS. 1 to 9. The present invention is not limited to these illustrations, but is represented by claims and intended to include all changes in the scope of claims and in the meaning and scope of equivalents. In this embodiment, a direction F in FIGS. 1 to 6 and 9 is defined as a forward direction concerning a front-rear direction. A direction H in FIGS. 1 to 3, 5, 7 and 8 is defined as an upward direction concerning a vertical direction. A direction R in FIGS. 1, 2, 4 and 6 to 8 is defined as a rightward direction concerning a lateral direction.

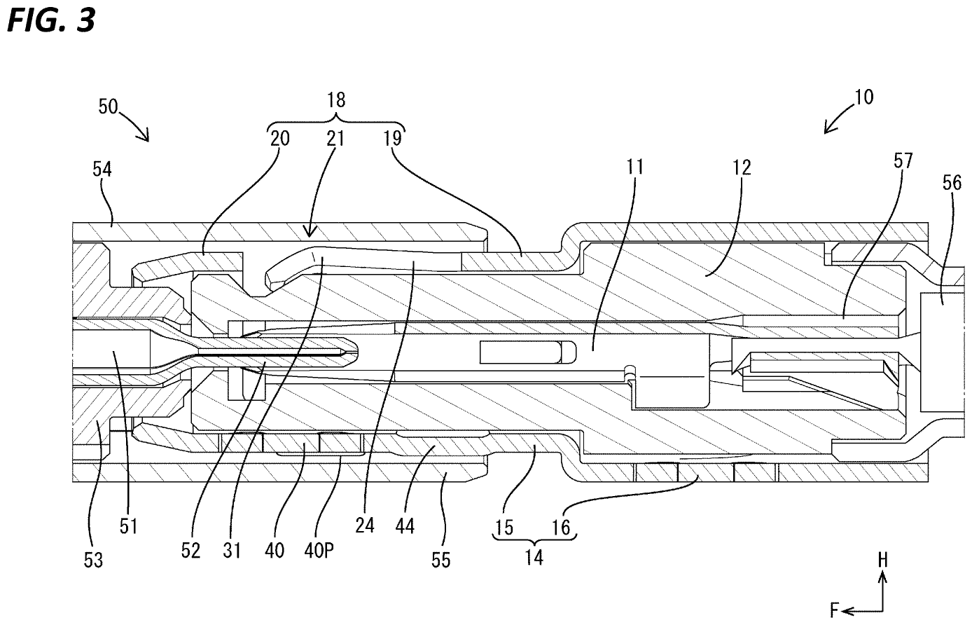

The shield connector is provided with a first connector 10 and a second connector 50 connectable and separable in the front-rear direction. The first connector 10 has a shape elongated in the front-rear direction as a whole. As shown in FIG. 3, the first connector 10 is configured by assembling a first inner conductor 11, a first dielectric 12 and a first outer conductor 14. The first inner conductor 11 is a tubular female terminal. A core wire 57 of a coaxial cable 56 is connected to a rear end part of the first inner conductor 11. The first inner conductor 11 is accommodated inside the first dielectric 12.

The first outer conductor 14 is a tubular member surrounding the entire first dielectric 12. The first outer conductor 14 is configured by uniting a tubular front member 15 made of metal and a tubular rear member 16 made of metal. The front member 15 is a single component including a hollow cylindrical large-diameter portion 17 and a tubular body portion 18 having a smaller diameter than the large-diameter portion 17. The large-diameter portion 17 is a part constituting a rear end side part of the front member 15, and fixed to a front end part of the rear member 16. A rear end part of the rear member 16 is conductively fixed to a shield member (not shown) of the coaxial cable 56.

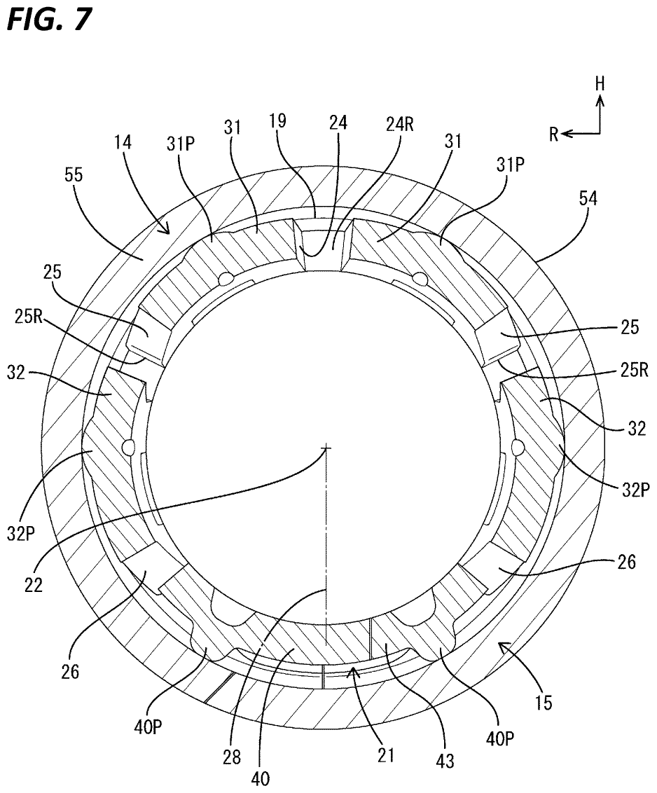

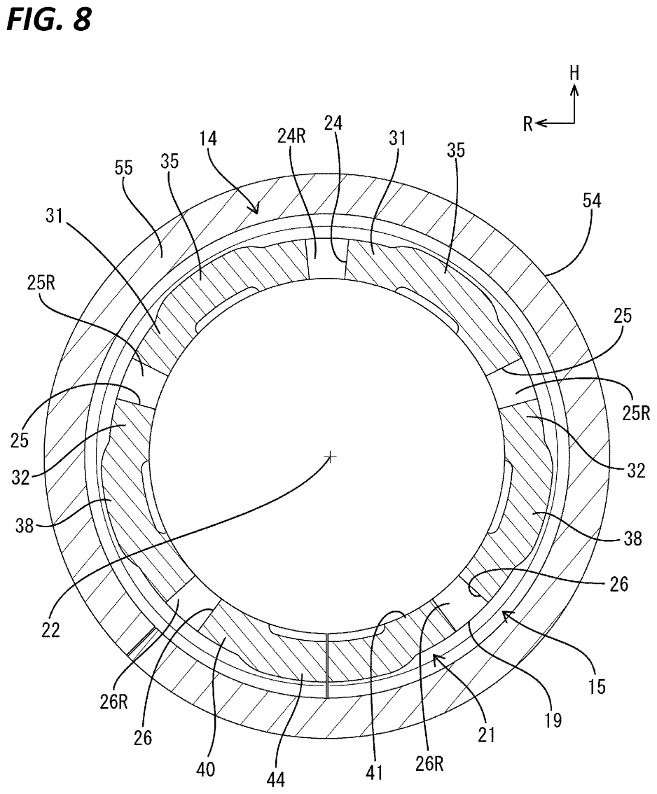

The tubular body portion 18 is a tubular part coaxially extending forward from the large-diameter portion 17 and constitutes front end side parts of the front member 15 and the first outer conductor 14. The tubular body portion 18 is constituted by a tubular supporting portion 19, a protecting portion 20 and a contact point constituting portion 21. The tubular supporting portion 19 is a tubular part constituting a rear end part of the tubular body portion 18. The protecting portion 20 is a tubular part constituting a front end part of the tubular body portion 18. In a front view of the first outer conductor 14 (tubular body portion 18), the tubular supporting portion 19 and the protecting portion 20 have a circular shape. Centers of the circular tubular supporting portion 19 and the protecting portion 20 in the front view are defined as axial centers 22 (see FIGS. 7 and 8). The tubular supporting portion 19 and the protecting portion 20 are so arranged that the axial centers 22 coincide in the front view.

In the following description, straight lines passing through the axial centers 22 and extending in the front-rear direction (direction parallel to a connection direction of the both connectors 10, 50) are defined as axes of the first outer conductor 14 and the tubular body portion 18. A direction along circles centered on the axial centers 22 in the front view is defined as a circumferential direction. A direction along a straight line passing through the axial centers 22 in the front view is defined as a radial direction.

The contact point constituting portion 21 is a part located between the tubular supporting portion 19 and the protecting portion 20 in the axial direction. The contact point constituting portion 21 is a part constituting fixed contact point portions 40P and movable contact point portions 31P, 32P to be described later. The contact point constituting portion 21 is formed with five side slits 24, 25 and 26 and one end slit 27. The side slits 24, 25 and 26 and the end slit 27 penetrate from the inner peripheral surface to the outer peripheral surface of the tubular body portion 18. The five side slits 24, 25 and 26 are arranged at intervals in the circumferential direction and extend in the front-rear direction along the axis as a whole. The end slit 27 extends in the circumferential direction along the rear end of the protecting portion 20 and is arranged to allow communication between the front ends of the five side slits 24, 25 and 26.

The five side slits 24, 25 and 26 include one first side slit 24, a pair of bilaterally symmetrical second side slits 25 and a pair of bilaterally symmetrical third side slits 26. As shown in FIGS. 7 and 8, the first side slit 24 is located on the uppermost end of the tubular body portion 18 in the front view and extends straight in parallel to the axis. The front end of the first side slit 24 communicates with the end slit 27. The base end (rear end) of a first base end slit 24R of the first side slit 24 is facing the front end edge of the tubular supporting portion 19. The first base end slit 24R constitutes a rear end part of the first side slit 24.

The pair of second side slits 25 are adjacently arranged on both left and right sides of the first side slit 24. When the second side slit 25 is viewed in the radial direction, the second side slit 25 is shaped to be slightly bent. The front end of the second side slit 25 communicates with the end slit 27. The base end (rear end) of the second side slit 25 is facing the front end edge of the tubular supporting portion 19. Out of the second side slit 25, a second base end slit 25R facing the front end of the tubular supporting portion 19 extends in parallel to the axis. The second base end slit 25R constitutes a rear end part of the second side slit 25.

The pair of third side slits 26 are arranged on a side opposite to the first side slit 24 across the second side slits 25. When the third side slit 26 is viewed in the radial direction, the third side slit 26 is shaped to be slightly bent. The front end of the third side slit 26 communicates with the end slit 27. The base end (rear end) of the third side slit 26 is facing the front end edge of the tubular supporting portion 19. Out of the third side slit 26, a third base end slit 26R facing the front end of the tubular supporting portion 19 extends in parallel to the axis. The third base end slit 26R constitutes a rear end part of the third side slit 26.

Out of the contact point constituting portion 21, parts defined by the first side slit 24, the pair of second side slits 25 and the end slit 27 constitute a pair of first spring portions 31. One first side slit 24 is a common space contributing to the formation of the pair of first spring portions 31. The pair of first spring portions 31 have a cantilever shape extending forward from the front end of the tubular supporting portion 19. The first spring portion 31 is a part resiliently deformable to be displaced in the radial direction. As shown in FIG. 7, a straight line in the vertical direction passing through the axial centers 22 in the front view is defined as an axis of symmetry 28. The pair of first spring portions 31 are bilaterally symmetrically shaped and positioned with respect to the axis of symmetry 28.

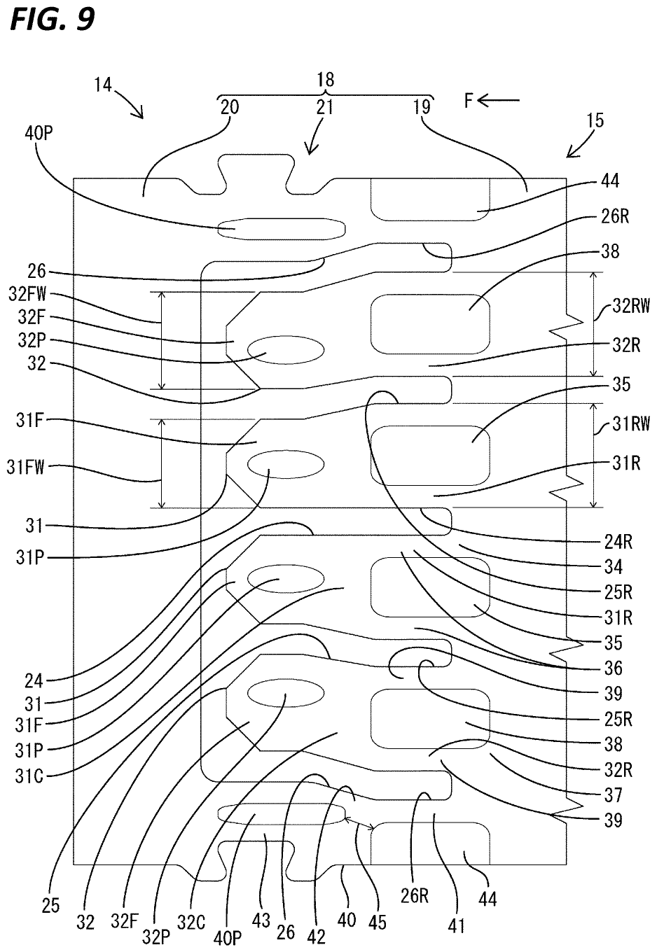

As shown in FIG. 9, the first spring portion 31 includes a first base end part 31R, a first intermediate part 31C and a first tip part 31F. The first base end part 31R is a part extending forward from the front end edge of the tubular supporting portion 19. A width 31RW in the circumferential direction of the first base end part 31R is constant from the rear end to the front end of the first base end part 31R. The first intermediate part 31C is a part extending forward from the front end of the first base end part 31R and has a trapezoidal shape gradually narrowed from a rear end toward a front end. The first tip part 31F is a part extending forward from the front end of the first intermediate part 31C. A maximum width 31FW in the circumferential direction of the first tip part 31F is smaller than the width 31RW of the first base end part 31R. The first movable contact point portion 31P is formed on the first tip part 31F. The first movable contact point portion 31P is a part formed by striking the first spring portion 31 and projects radially outward from the outer peripheral surface of the first spring portion 31. The first movable contact point portion 31P is resiliently displaced integrally with the first spring portion 31.

Out of the contact point constituting portion 21, parts defined by the second side slits 25, the pair of third side slits 26 and the end slit 27 constitute a pair of second spring portions 32. One second side slit 25 is a common space contributing to the formation of the first spring portion 31 and the second spring portion 32. One third side slit 26 is a common space contributing to the formation of the second spring portion 32 and an arcuate supporting portion 40 to be described later. The pair of second spring portions 32 have a cantilever shape extending forward from the front end of the tubular supporting portion 19. The second spring portion 32 is a part resiliently deformable to be displaced in the radial direction. The pair of second spring portions 32 are bilaterally symmetrically shaped and positioned with respect to the axis of symmetry 28.

As shown in FIG. 9, the second spring portion 32 includes a second base end part 32R, a second intermediate part 32C and a second tip part 32F. The second base end part 32R is a part extending forward from the front end edge of the tubular supporting portion 19. A width 32RW in the circumferential direction of the second base end part 32R is constant from the rear end to the front end of the second base end part 32R. The second intermediate part 32C is a part extending forward from the front end of the second base end part 32R and has a trapezoidal shape gradually narrowed from a rear end toward a front end. The second tip part 32F is a part extending forward from the front end of the second intermediate part 32C. A maximum width 32FW in the circumferential direction of the second tip part 32F is smaller than the width 32RW of the second base end part 32R. The second movable contact point portion 32P is formed on a tip part of the second spring portion 32. The second movable contact point portion 32P is a part formed by striking the second spring portion 32 and projects radially outward from the outer peripheral surface of the second spring portion 32. The second movable contact point portion 32P is resiliently displaced integrally with the second spring portion 32.

Out of the tubular supporting portion 19, a part connected to the first base end part 31R of the first spring portion 31 is defined as a first boundary portion 34. The tubular body portion 18 is formed with first movable side reinforcing portions 35 for enhancing resilient forces of the first spring portions 31. The first movable side reinforcing portion 35 projects radially outward. The first movable side reinforcing portion 35 has a rectangular shape having long sides extending in parallel to the axial direction when viewed in the radial direction. The first movable side reinforcing portion 35 is formed from the front end to the rear end of the first base end part 31R. A formation range in the axial direction of the first movable side reinforcing portion 35 in the first base end part 31R is larger than that of the first movable side reinforcing portion 35 in the first boundary portion 34.

The first movable side reinforcing portion 35 is formed by striking a part from the first base end part 31R to the first boundary portion 34. Out of the first base end part 31R, long sides of the first movable side reinforcing portion 35 and side edge parts along the first base end slit 24R and the second base end slit 25R function as a pair of first reinforcement held portions 36. The first reinforcement held portion 36 has a rectangular shape having long sides extending in parallel to the axial direction.

Out of the tubular supporting portion 19, a part connected to the second base end part 32R of the second spring portion 32 is defined as a second boundary portion 37. The tubular body portion 18 is formed with second movable side reinforcing portions 38 for enhancing resilient forces of the second spring portions 32. The second movable side reinforcing portion 38 projects radially outward. The second movable side reinforcing portion 38 has a rectangular shape having long sides extending in parallel to the axial direction when viewed in the radial direction. The second movable side reinforcing portion 38 is formed from the front end to the rear end of the second base end part 32R. A formation range in the axial direction of the second movable side reinforcing portion 38 in the second base end part 32R is larger than that of the second movable side reinforcing portion 38 in the second boundary portion 37.

The second movable side reinforcing portion 38 is formed by striking a part from the second base end part 32R to the second boundary portion 37. Out of the second base end part 32R, long sides of the second movable side reinforcing portion 38 and side edge parts along the second base end slit 25R and the third slit function as a pair of second reinforcement held portions 39. The second reinforcement held portion 39 has a rectangular shape having long sides extending in parallel to the axial direction.

Out of the contact point constituting portion 21, a part between the pair of third side slits 26 is defined as the arcuate supporting portion 40. The arcuate supporting portion 40 is a part connecting a lower end part of the front end edge of the tubular supporting portion 19 and that of the rear end edge of the protecting portion 20. In the front view, the arcuate supporting portion 40 has an arcuate shape. A formation range in the circumferential direction of the arcuate supporting portion 40 is larger than 60°.

The arcuate supporting portion 40 is composed of a narrow portion 41, a trapezoidal portion 42 and a wide portion 43. The narrow portion 41 is a part extending forward from the front end edge of the tubular supporting portion 19. A width in the circumferential direction of the narrow portion 41 is constant from the front end to the rear end of the narrow portion 41. A formation region of the narrow portion 41 in the axial direction is the same region as formation regions of the first spring portions 31 and the second base end parts 32R. The trapezoidal portion 42 is a part extending forward from the front end of the narrow portion 41. The shape of the trapezoidal portion 42 when viewed in the radial direction is an isosceles trapezoidal shape. A width of the trapezoidal portion 42 gradually increases from the rear end toward the front end of the trapezoidal portion 42. A formation region of the trapezoidal portion 42 in the axial direction is the same region as formation regions of the first intermediate parts 31C and the second intermediate parts 32C. The wide portion 43 is a part extending forward from the front end of the trapezoidal portion 42. A width of the wide portion 43 is constant from the front end to the rear end of the wide portion 43. A formation region of the wide portion 43 in the axial direction is the same region as formation regions of the first tip parts 31F and the second tip parts 32F.

The arcuate supporting portion 40 is formed with a pair of the fixed contact point portions 40P bilaterally symmetrical with respect to the axis of symmetry 28. The pair of fixed contact point portions 40P are arranged to form an angle of 60° in the circumferential direction. The fixed contact point portion 40P is a part formed by striking the arcuate supporting portion 40 and projects radially outward from the outer peripheral surface of the arcuate supporting portion 40. The fixed contact point portion 40P is a part which is not relatively displaced with respect to the contact point constituting portion 21 (tubular body portion 18). The fixed contact point portion 40P has a shape elongated in the axial direction. The fixed contact point portion 40P is formed over the wide portion 43 and the trapezoidal portion 42.

The contact point constituting portion 21 is formed with a fixed side reinforcing portion 44. The fixed side reinforcing portion 44 is formed by striking a part from the narrow portion 41 to the front end part of the arcuate supporting portion 40. The fixed side reinforcing portion 44 projects radially outward. The fixed side reinforcing portion 44 has a rectangular shape having long sides extending in the axial direction when viewed in the radial direction. In the axial direction, a formation range of the fixed side reinforcing portion 44 is the same as that of the movable side reinforcing portions. Similarly to the first and second movable side reinforcing portions 35, 38, the fixed side reinforcing portion 44 is arranged to cross a virtual line (not shown) in the circumferential direction connecting the rear end of the first base end slit 24R, those of the second base end slits 25R and those of the third base end slits 26R.

In the circumferential direction, the pair of fixed contact point portions 40P are at least partially or entirely located closer to the third side slits 26 than both side edges in the front-rear direction along the long sides of the fixed side reinforcing portion 44. A shown in FIG. 9, a shortest straight path 45, which is a shortest interval between the fixed contact point portion 40P and the fixed side reinforcing portion 44, extends in a direction oblique to the axis of the tubular body portion 18. Therefore, the shortest straight path 45 is ensured to be long as compared to a shortest distance in the axial direction between the rear end of the fixed contact point portion 40P and the front end of the fixed side reinforcing portion 44. By ensuring the long shortest straight path 45, the arcuate supporting portion 40 is easily supported by a jig when the fixed contact point portion 40P and the fixed side reinforcing portion 44 are formed by striking.

The second connector 50 has a shape elongated in the front-rear direction as a whole. As shown in FIG. 3, the second connector 50 is configured by assembling a second inner conductor 51, a second dielectric 53 and a second outer conductor 54. The second inner conductor 51 is a male terminal including a tab 52. A core wire (not shown) of a coaxial cable (not shown) is connected to the second inner conductor 51. The second inner conductor 51 is accommodated inside the second dielectric 53.

The second outer conductor 54 is a tubular member surrounding the entire second dielectric 53. A tip part of the second outer conductor 54 functions as a hollow cylindrical fitting portion 55. An inner diameter of the fitting portion 55 is set to be smaller than an inner diameter of a virtual circle (not shown) circumscribing at least three contact point portions 31P, 32P and 40P, out of the two fixed contact point portions 40P and the four movable contact point portions 31P, 32P, in a free state where the first and second spring portions 31, 32 are not resiliently deformed.

If the first and second connectors 10, 50 are connected, the first and second inner conductors 11, 51 are connected and the fitting portion 55 of the second outer conductor 54 is externally fit to the contact point constituting portion 21 of the first outer conductor 14. If the first and second outer conductors 14, 54 are fit, the six contact point portions (the pair of fixed contact point portions 40P, the pair of first movable contact point portions 31P and the pair of second movable contact point portions 32P) contact the inner peripheral surface of the fitting portion 55 with the four spring portions 31, 32 resiliently deformed radially inward. At this time, radially inward reaction forces act on the four spring portions 31, 32 from the fitting portion 55 due to resilient restoring forces of the four spring portions 31, 32. By these reaction forces, the six contact point portions 31P, 32P and 40P and the fitting portion 55 are connected with a predetermined contact pressure.

The first base end part 31R and the first boundary portion 34 of the first spring portion 31 are parts serving as a deflection fulcrum when the first spring portion 31 is resiliently deformed in the radial direction. The flexural rigidity of the first base end part 31R and the first boundary portion 34 is enhanced by the first movable side reinforcing portion 35. When the first spring portion 31 is resiliently deformed in the radial direction, the first movable contact point portion 31P and the second outer conductor 54 come into contact with a high contact pressure. The second base end part 32R and the second boundary portion 37 of the second spring portion 32 are parts serving as a deflection fulcrum when the second spring portion 32 is resiliently deformed in the radial direction. The flexural rigidity of the second base end part 32R and the second boundary portion 37 is enhanced by the second movable side reinforcing portion 38. When the second spring portion 32 is resiliently deformed in the radial direction, the second movable contact point portion 32P and the second outer conductor 54 come into contact with a high contact pressure. Since a contact resistance between the first and second outer conductors 14, 54 is reduced in this way, shielding performance is improved.

The shield connector of this embodiment is provided with the tubular first outer conductor 14 and the tubular second outer conductor 54. The first outer conductor 14 includes the first and second spring portions 31, 32 resiliently deformable in the radial direction. The second outer conductor 54 contacts the first and second spring portions 31, 32 in the radial direction. The first spring portion 31 is a part defined by the first and second side slits 24, 25 in the axial direction formed in the first outer conductor 14. The first spring portion 31 is formed with the first movable side reinforcing portion 35 for enhancing the flexural rigidity of the first spring portion 31. The second spring portion 32 is a part defined by the second and third side slits 25, 26 in the axial direction formed in the second outer conductor 14. The second spring portion 32 is formed with the second movable side reinforcing portion 38 for enhancing the flexural rigidity of the second spring portion 32.

According to this configuration, the flexural rigidity of the first spring portion 31 is enhanced by the first movable side reinforcing portion 35, and that of the second spring portion 32 is enhanced by the second movable side reinforcing portion 38. When the first and second spring portions 31, 32 are resiliently deformed in the radial direction, large stresses are generated in the first and second spring portions 31, 32. Since a contact pressure between the first and second outer conductors 14, 54 is stabilized in a high state in this way, the contact resistance between the first and second outer conductors 14, 54 is reduced, wherefore shielding performance can be improved.

The first and second spring portions 31, 32 have a cantilever shape extending in the axial direction from the tubular supporting portion 19 constituting the first outer conductor 14. The first tip part 31F of the first spring portion 31 is formed with the first movable contact point portion 31P for contacting the second outer conductor 54. The first movable side reinforcing portion 35 is arranged in a region including the first base end part 31R connected to the tubular supporting portion 19, out of the first spring portion 31. Since the first base end part 31R serving as a fulcrum when the first spring portion 31 is resiliently deformed is reinforced by the first movable side reinforcing portion 35, the resilient force of the first spring portion 31 can be effectively enhanced. The second tip part 32F of the second spring portion 32 is formed with the second movable contact point portion 32P for contacting the second outer conductor 54. The second movable side reinforcing portion 38 is arranged in a region including the second base end part 32R connected to the tubular supporting portion 19, out of the second spring portion 32. Since the second base end part 32R serving as a fulcrum when the second spring portion 32 is resiliently deformed is reinforced by the second movable side reinforcing portion 38, the resilient force of the second spring portion 32 can be effectively enhanced.

The first movable side reinforcing portion 35 is formed from the first base end part 31R to the first boundary portion 34, which is a boundary portion with the first spring portion 31 in the tubular supporting portion 19, in the axial direction. When the first spring portion 31 is resiliently deformed, not only the first base end part 31R, but also the first boundary portion 34 in the tubular supporting portion 19 is deflected. Since the first movable side reinforcing portion 35 enhances the rigidity of not only the first base end part 31R, but also the first boundary portion 34, the resilient force of the first spring can be effectively enhanced.

The second movable side reinforcing portion 38 is formed from the second base end part 32R to the second boundary portion 37, which is a boundary portion with the second spring portion 32 in the tubular supporting portion 19, in the axial direction. When the second spring portion 32 is resiliently deformed, not only the second base end part 32R, but also the second boundary portion 37 in the tubular supporting portion 19 is deflected. Since the second movable side reinforcing portion 38 enhances the rigidity of not only the second base end part 32R, but also the second boundary portion 37, the resilient force of the second spring portion 32 can be effectively enhanced.

Since the width 31RW of the first base end part 31R is set to be larger than the width 31FW of the first tip part 31F, the resilient force of the first spring portion 31 is effectively enhanced. Since the width 32RW of the second base end part 32R is set to be larger than the width 32FW of the second tip part 32F, the resilient force of the second spring portion 32 is effectively enhanced.

The first and second movable side reinforcing portions 35, 38 are shaped to project radially outward from the outer peripheral surface of the first outer conductor 14. The first outer conductor 14 is formed by winding a metal plate material in the form of a flat plate formed with the first spring portions 31, the second spring portions 32, the first movable side reinforcing portions 35 and the second movable side reinforcing portions 38 around a cylindrical core metal (not shown). Since the first and second movable side reinforcing portions 35, 38 project radially outward, the core metal needs not be formed with a recess for avoiding interference with the first and second movable side reinforcing portions 35, 38.

The first movable side reinforcing portion 35 is shaped by causing a widthwise central part of the first base end part 31R to project in the radial direction. The side edge parts along the first and second side slits 24, 25, out of the first base end part 31R, function as the first reinforcement held portions 36 to be held by the jig (not shown) when the first movable side reinforcing portions 35 are formed by striking. The first base end slit 24R defining the first base end part 31R, out of the first side slit 24, and the second base end slit 25R defining the first base end part 31R, out of the second side slit 25, extend in parallel to the axis of the first outer conductor 14. Since the side edge of the first reinforcement held portion 36 is parallel to the axis, the first reinforcement held portion 36 is easily held by the jig in a process of forming the first movable side reinforcing portion 35 by striking.

The second movable side reinforcing portion 38 is shaped by causing a widthwise central part of the second base end part 32R to project in the radial direction. The side edge parts along the second and third side slits 25, 26, out of the second base end part 32R, function as the second reinforcement held portions 39 to be held by the jig (not shown) when the second movable side reinforcing portions 38 are formed by striking. The second base end slit 24R defining the second base end part 32R, out of the second side slit 25, and the third base end slit 26R defining the second base end part 32R, out of the third side slit 26, extend in parallel to the axis of the second outer conductor 14. Since the side edge of the second reinforcement held portion 39 is parallel to the axis, the second reinforcement held portion 39 is easily held by the jig in a process of forming the second movable side reinforcing portion 38 by striking.

### Other Embodiments

The present invention is not limited to the above described and illustrated embodiment, but is represented by claims. The present invention includes all changes in the scope of claims and in the meaning and scope of equivalents and also includes the following embodiments.

The reinforcing portion may be arranged only in a region not including the base end part of the spring portion.

The formation range of the reinforcing portion in the axial direction may be a range not including the boundary portion with the spring portion in the tubular supporting portion.

The reinforcing portion may be shaped to project further radially inward than the inner surface of the tubular supporting portion.

### LIST OF REFERENCE NUMERALS

10 . . . first connector
11 . . . first inner conductor
12 . . . first dielectric
14 . . . first outer conductor
15 . . . front member
16 . . . rear member
17 . . . large-diameter portion
18 . . . tubular body portion
19 . . . tubular supporting portion
20 . . . protecting portion
21 . . . contact point constituting portion
22 . . . axial center
24 . . . first side slit (side slit)
24R . . . first base end slit (base end slit)
25 . . . second side slit (side slit)
25R . . . second base end slit (base end slit)
26 . . . third side slit (side slit)
26R . . . third base end slit (base end slit)
27 . . . end slit
28 . . . axis of symmetry
31 . . . first spring portion (spring portion)
31C . . . first intermediate part
31F . . . first tip part (tip part)
31FW . . . maximum width of first tip part
31P . . . first movable contact point portion (contact point portion)
31R . . . first base end part (base end part)
31RW . . . width of first base end part
32 . . . second spring portion (spring portion)
32C . . . second intermediate part
32F . . . second tip part (tip part)
32FW . . . maximum width of second tip part
32P . . . second movable contact point portion (contact point portion)
32R . . . second base end part (base end part)
32RW . . . width of second base end part
34 . . . first boundary portion (boundary portion)
35 . . . first movable side reinforcing portion (reinforcing portion)
36 . . . first reinforcement held portion (reinforcement held portion)
37 . . . second boundary portion (boundary portion)
38 . . . second movable side reinforcing portion (reinforcing portion)
39 . . . second reinforcement held portion (reinforcement held portion)
40 . . . arcuate supporting portion
40P . . . fixed contact point portion
41 . . . narrow portion
42 . . . trapezoidal portion
43 . . . wide portion
44 . . . fixed side reinforcing portion
45 . . . short straight path
50 . . . second connector
51 . . . second inner conductor
52 . . . tab
53 . . . second dielectric
54 . . . second outer conductor
55 . . . fitting portion
56 . . . coaxial cable
57 . . . core wire

1. A shield connector, comprising:
a tubular first outer conductor including a spring portion resiliently deformable in a radial direction; and
a tubular second outer conductor configured to contact the spring portion in the radial direction,
the spring portion being a part defined by a side slit in an axial direction formed in the first outer conductor,
the spring portion being formed with a reinforcing portion for enhancing flexural rigidity of the spring portion,
the first outer conductor being a single component including a tubular supporting portion, a protecting portion and a contact point constituting portion located between the tubular supporting portion and the protecting portion,
the protecting portion being a tubular part constituting an end part in the axial direction of the first outer conductor,
the contact point constituting portion including the spring portion and an arcuate supporting portion, and
the arcuate supporting portion connecting the tubular supporting portion and the protecting portion.

2. The shield connector of claim 1, wherein:
the spring portion has a cantilever shape extending in the axial direction from the tubular supporting portion constituting the first outer conductor,
a contact point portion for contacting the second outer conductor is formed on a tip part of the spring portion, and
the reinforcing portion is arranged in a region including a base end part connected to the tubular supporting portion, out of the spring portion.

3. The shield connector of claim 2, wherein the reinforcing portion is formed from the base end part to a boundary portion with the spring portion in the tubular supporting portion in the axial direction.

4. The shield connector of claim 2, wherein the spring portion is formed such that a width of the base end part is larger than that of the tip part.

5. The shield connector of claim 1, wherein the reinforcing portion is shaped to project radially outward from an outer peripheral surface of the first outer conductor.

6. The shield connector of claim 2, wherein:
the reinforcing portion is shaped by causing a widthwise central part of the base end part to project in the radial direction,
a side edge part along the side slit, out of the base end part, functions as a reinforcement held portion when the reinforcing portion is formed by striking, and
a base end slit defining the base end part, out of the side slit, extends in parallel to an axis of the first outer conductor.
